(19) United States
(12) Patent Application Publication
(10) Pub. No.: US 2017/0006828 A1
(43) Pub. Date: Jan. 12, 2017

(54) ANIMAL CLOTHING HAVING ROLL UP LEGGINGS

(71) Applicant: PROTECT ME ALERT SERIES NO: 8372683 CANADA INC., Mount Royal (CA)

(72) Inventor: Lorne Miller, Mount Royal (CA)

(21) Appl. No.: 15/202,944

(22) Filed: Jul. 6, 2016

Related U.S. Application Data
(60) Provisional application No. 62/189,507, filed on Jul. 7, 2015.

(51) Int. Cl. A01K 13/00; A44B 1/00; A44B 17/00; A41F 19/00

(52) U.S. Cl. CPC A01K 13/006; A41F 19/005; A44B 1/00; A44B 17/0041

(57) ABSTRACT

An article of clothing for use with an animal having adjustable length leggings is provided. The article of clothing has a plurality of leggings sized to cover a portion of the animal's legs, either two or four of the legs. Internal to the leggings are one or more straps that may be utilized to secure, via a fastener system, the leggings in a rolled up arrangement. By utilizing the adjustable leggings, appropriate levels of warmth and comfort may be provided for the animal.

### CROSS-REFERENCE TO RELATED APPLICATIONS

The present application claims the benefit of U.S. Provisional Patent Application Ser. No. 62/189,507, which was filed on Jul. 7, 2015, by Lorne Miller for ANIMAL CLOTHING HAVING ROLL UP LEGGINGS, which is hereby incorporated by reference.

### BACKGROUND OF THE INVENTION

Many pet owners purchase clothing for their pets to wear. This clothing may be utilized for a variety of reasons, including, for example, to provide additional warmth in cold weather, to protect the animal from environmental factors, for aesthetic purposes, etc. A common article of clothing for pets is a jacket, which may be used to provide additional warmth for an animal, such as a dog, when exposed to cold temperatures. As dogs commonly are taken for walks outdoors, they often are exposed to extreme temperatures especially in northern climates that have harsh winters. In many locations, winters may vary wildly in temperature, snowfall accumulation, etc. This may necessitate the owner acquiring a plurality of differing coats/jackets for an animal depending on current weather conditions. This may add significantly to the total cost of ownership of the animal. Further, a pet owner may not have the necessary financial means to require a significant number of differing types of clothing for varying weather conditions. This may mean that a animal, such as a dog is either overdressed or underdressed for a given weather condition. As will be appreciated, this may increase the chance of an animal overheating and/or suffering negative effects of the cold, such as frostbite, hypothermia, etc.

### SUMMARY OF THE INVENTION

The disadvantages of the prior art are overcome by providing an article of clothing for an animal that has roll up leggings to provide varying degrees of protection from the elements. An article of clothing, such as a jacket/coat, is configured for an animal, such as a dog. The article of clothing comprises a central portion that covers a substantial portion of the animals torso and includes a plurality of leg coverings (leggings). The leggings may, in one embodiment of the present invention, only be provided for the front legs of animal. In alternative embodiments of the present invention, all four legs of the animal may be provided with leggings. The leggings include one or more straps, located internally to the legging, that may be utilized to secure the legging in a rolled up arrangement by securing to a fastener.

### BRIEF DESCRIPTION OF THE DRAWINGS

The above and further advantages of the present invention prescribed herein in relation to the following figures in which like reference numerals indicate identical or functionally similar elements, of which:

FIG. 1 is a frontal perspective view of an exemplary article of clothing with roll up leggings in accordance with an illustrative embodiment of the present invention;

FIG. 2 is a close-up perspective view of the operation of the roll up leggings in accordance with an illustrative embodiment of the present invention;

FIG. 3 is a close-up perspective view of the operation of the role of leggings when in a rolled up configuration in accordance with an illustrative embodiment of the present invention;

FIG. 4 is a close-up perspective view of the operation of the roll up leggings when unrolled in accordance with an illustrative embodiment of the present invention;

FIG. 5 is an underside perspective review of an article of clothing having rollup leggings in accordance with an illustrative embodiment of the present invention;

FIG. 6A is a close-up perspective of the operation of the fasteners in accordance with an illustrative embodiment of the present invention; and

FIG. 6B is a close-up perspective view of an unrolled lagging in accordance with an illustrative embodiment of the present convention.

### DETAILED DESCRIPTION OF AN ILLUSTRATIVE EMBODIMENT

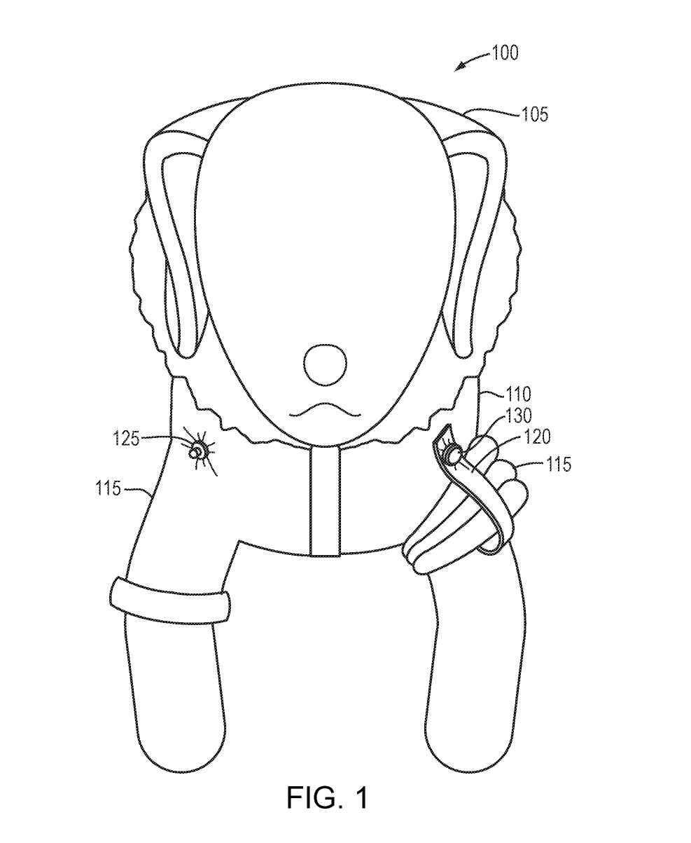

FIG. 1 is an exemplary perspective view 100 of an article of clothing in accordance with an illustrative embodiment the present invention. The article of clothing 110 is illustratively designed for wear by an animal and is shown on an animal 105, such as a dog. It should be noted that while the description contained herein is in reference to an animal 105 being a dog, the principles of the present invention may be utilized in relation to other animals. As such, the description of a dog should be taken as exemplary only. Illustrative, the article of clothing 110 is shown as a jacket/coat for animal 105.

The article of clothing illustratively comprises a plurality of leg coverings (leggings) 115 that are configured to cover a portion of the animals front legs. It should be noted that in alternative embodiments of the present invention, the article of clothing may contain four leggings so that each of the animal's legs may be covered. When unrolled, each legging is designed to cover a substantial portion of the animal's leg. The length of each legging may be set based on appropriate design choices when implementing the present invention to meet the needs of warmth, aesthetics, etc. As such, the description and views of how much of the animal's leg is covered should be taken as exemplary only.

In view 100, the animal's right leg is covered by unrolled legging 115. A fastener 125 is exposed on the outer surface the article of clothing for use in attaching a strap (shown in relation to left left) to secure the legging when in a rolled up configuration. Such a rolled up configuration is shown on the animal s left leg where the legging 115 is rolled up and secured by a strap 120 having a faster 130. In FIG. 1, the fasteners 125, 130 are shown as the two sides of a conventional clasp. However, in accordance with alternative embodiments of the present invention, the fastener may comprise other forms, e.g., buttons, zippers, clips, etc. As will be appreciated by those skilled in the art, any technique for fastening the strap to the body of the article of clothing may be utilized. As such, the description of fastener 125, 130 being components of a clasp should be taken as exemplary only.

The present invention enables articles of clothing designed to be worn by animals to have adjustable leggings that may be either rolled up or down to vary the amount of warmth provided by the article of clothing. Thus, in very cold temperatures, the leggings may be rolled down to provide additional coverage and warmth for the animal. Similarly, in warmer temperatures, the leggings may be rolled up. This technique obviates the need to have both short and long legged articles of clothing for an animal. That is, a single article clothing may be utilized in varying weather conditions.

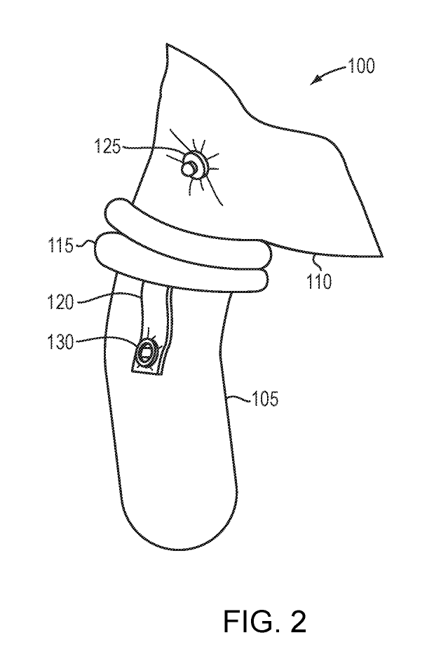

FIG. 2 is a close-up perspective view of the rolled up legging 115 that has not been secured yet. The article of clothing 110 is shown with a fastener 125 located on the external surface. Strap 120 is shown hanging on the inside of the legging 115 with a corresponding second fastener 130. In accordance with an illustrative embodiment of the present invention, one end of strap 120 is connected, either by sewing or otherwise being joined to interior the article of clothing 110. In alternative embodiments, the strap may be integrated into the interior of the legging, etc. As such, any technique where on end of the strap is secured to either the body of the article of clothing or the legging may be utilized in accordance with alternative embodiments of the present invention.

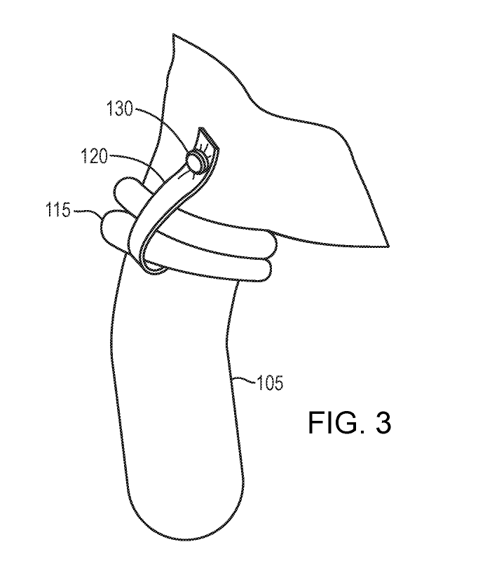

FIG. 3 is a close-up perspective view showing a rolled up legging 115 being secured by strap 120 secured by fasteners 125, 130. In the rolled up configuration, the strap 120 provides support for the legging 115 so that it does not slip down the animal's leg while the animal is engaged in exercise, etc. In operation, a user will roll the legging up or down, as desired, and secure it with the one or more straps.

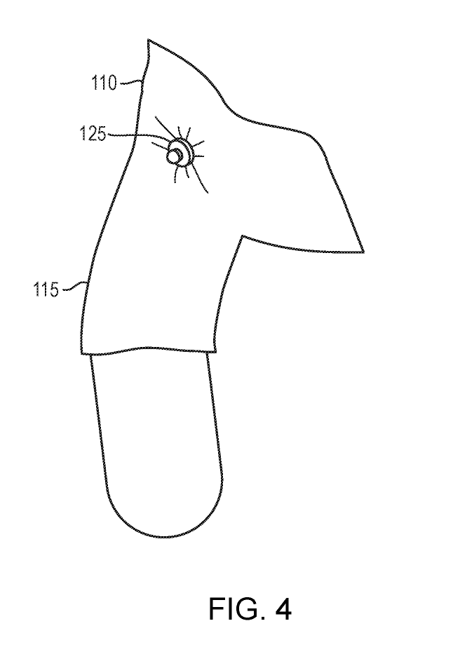

FIG. 4 is a close-up perspective view showing a legging unrolled in accordance with an illustrative embodiment of the present invention. In the view of FIG. 4, the article of clothing 110 is shown with the legging 115 unrolled. Strap 120 with corresponding faster 130 would be located inside of the legging 115, i.e. between the legging 115 and the leg of the animal 105. Faster 125 is visible on the exterior of the article of clothing.

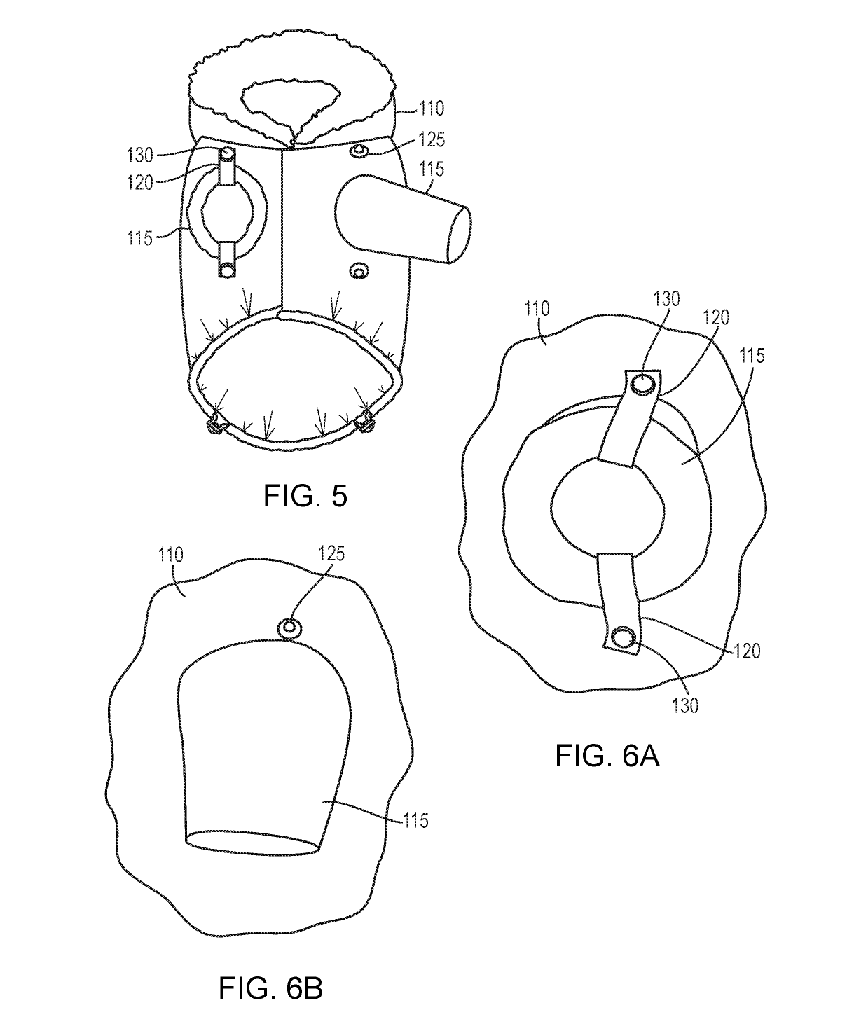

FIG. 5 is an exemplary view of an article of clothing showing a plurality of straps in use in accordance with an illustrative embodiment of the present invention. The article of clothing 110 is illustratively depicted for use on an animal (not shown). The jacket's right side is shown as having the legging rolled up and a plurality of straps 120 engaged by fasteners 130. In this illustrative embodiment, two straps 120 are utilized to secure the legging 115. The straps are illustratively arranged on opposing sides of the opening for the legging 115. However, it should be noted that in alternative embodiments of the present invention, a varying number of straps may be utilized and/or the straps may be positioned in differing locations. Thus, the description of two straps arranged on opposing sides of the leggings should be taken as exemplary only.

FIG. 6A is a close up view of a rolled up legging 115 being secured by a plurality of straps 120 and secured by fasteners 125, 130. Similarly, FIG. 6B is a close up view of an unrolled legging 115 in accordance with an illustrative embodiment of the present invention.

Various embodiments of the present invention have been described herein. However, it should be noted that the various embodiments described herein are exemplary only and that the teachings of the present invention may be utilized in varying other configurations and/or embodiments. As such, the description contained herein should not be viewed as limiting.

What is claimed is:

1. An article of clothing comprising:
a body portion having a first legging and a second legging, the first and second leggings extending from an external side of the body portion;
a first body fastener and a second body fastener, the first and second body fasteners attached to the external side of the body portion;
a first strap, the first strap operatively attached at a first end to an interior side of the body portion, the first strap having a first strap fastener located at substantially a second end of the first strap;
a second strap, the second strap operatively attached at a first end to the interior side of the body portion, the second strap having a second strap fastener located at substantially a second end of the second strap;
wherein the first legging is configured to be rolled up and secured by the first strap by securing the first strap fastener to the first body fastener; and
wherein the second legging is configured to be rolled up and secured by the second strap by securing the second strap fastener to the second body fastener.

2. The article of clothing of claim 1 further comprising a third legging and a fourth legging, the third and fourth leggings extending from the external side of the body portion.

3. The article of clothing of claim 1 further comprising:
a third body fastener attached to the external side of the body portion;
a third strap, the third strap operatively attached at a first end to the interior side of the body portion, the third strap having a third strap fastener located at substantially a second end of the third strap; and
wherein the first legging is further configured to be secured by the third strap by securing the third strap fastener to the third body fastener.

4. The article of clothing of claim 1 wherein the first body fastener and the first strap fastener comprise portions of a clasp.

5. The article of clothing of claim 1 wherein the first body fastener comprises a button and the first strap fastener comprises a buttonhole.
